(19) United States
(12) Patent Application Publication
(10) Pub. No.: US 2026/0092618 A1
(43) Pub. Date: Apr. 2, 2026

(54) WALL FASTENER SYSTEM

(71) Applicant: Ranjiv JAIN, Seattle, WA (US)

(72) Inventor: Ranjiv JAIN, Seattle, WA (US)

(21) Appl. No.: 19/344,262

(22) Filed: Sep. 29, 2025

Related U.S. Application Data
(60) Provisional application No. 63/700,290, filed on Sep. 27, 2024.

(51) Int. Cl. F16B 5/00; E04F 13/08

(52) U.S. Cl. CPC F16B 5/0088; E04F 13/0801; F16B 5/0032

(57) ABSTRACT

A wall fastener system includes a structure-engaging insert configured to be secured to a structure. The structure-engaging insert includes a base plate and a protruding threaded connector extending outwardly from the base plate. The wall fastener system further includes a rail-engaging insert including a top plate and a protruding threaded connector extending from the top plate toward the structure. The protruding threaded connector of the rail-engaging insert is threadedly connected to the protruding threaded connector of the structure-engaging insert to selectively vary a spacing between the base plate and the top plate of the rail-engaging insert.

### CROSS-REFERENCE TO RELATED APPLICATIONS

This application claims the benefit of priority under 35 USC § 119 (e) of U.S. Provisional Patent Application No. 63/700,290 filed Sep. 27, 2024. The contents of the application identified in this paragraph are incorporated into the present application by reference in their entirety to the extent permitted by applicable law.

### BACKGROUND OF THE DISCLOSURE

The present disclosure relates generally to a system or device for fastening elements of a wall, or elements such as a sheathing, to a portion of a building, such as a wall, ceiling, or floor of a building. The sheathing or any other attached element using the wall fastener system in certain uses is a generally flat panel, but the attached element may in other uses be an element of any shape which the user may desire to mount and align using a wall fastener system with adjustability as disclosed herein. A device or system according to the present disclosure may provide a “live” or movable anchor rather than a “dead” or fixed anchor.

### BRIEF SUMMARY OF THE DISCLOSURE

Briefly stated, one aspect of the present disclosure is directed to a wall fastener system including a structure-engaging insert configured to be secured to a structure. The structure-engaging insert includes a base plate and a protruding threaded connector extending outwardly from the base plate. The wall fastener system further includes a rail-engaging insert including a top plate and a protruding threaded connector extending from the top plate toward the structure. The protruding threaded connector of the rail-engaging insert is threadedly connected to the protruding threaded connector of the structure-engaging insert to selectively vary a spacing between the base plate and the top plate of the rail-engaging insert.

In any embodiment, a wall fastener system may include: (a) a structure-engaging insert configured to be secured to a structure, the structure-engaging insert including a base plate and a protruding threaded connector extending outwardly from the base plate; and (b) a rail-engaging insert including a top plate and a protruding threaded connector extending from the top plate toward the structure, (c) wherein the protruding threaded connector of the rail-engaging insert is threadedly connected to the protruding threaded connector of the structure-engaging insert so as to selectively vary a spacing between the base plate and the top plate of the rail-engaging insert.

In any embodiment, a wall fastener system may further include a slotted rail secured to the top plate of the rail-engaging insert, the slotted rail being spaced from the base plate.

In any embodiment, a wall fastener system may further include a locking element configured to secure the structure-engaging insert and the rail-engaging insert against relative rotation.

In any embodiment, a wall fastener system may further include a spacer disposed between the rail-engaging insert and the structure-engaging insert, the spacer being threadedly connected to each to increase the spacing between the base plate and the top plate.

In any embodiment, a wall fastener system may be provided, wherein the slotted rail includes a primary panel and a leg intersecting the primary panel to define a slot configured to receive the top plate of the rail-engaging insert.

In any embodiment, a wall fastener system may be provided, wherein the slotted rail further includes a second leg disposed opposite the leg and configured to capture the top plate between the slot and the second leg.

In any embodiment, a wall fastener system may be provided, wherein the slotted rail includes a pair of opposing legs, each leg including a foot extending generally parallel to the primary panel so as to form two slots for receiving the top plate of the rail-engaging insert.

In any embodiment, a wall fastener system may be provided, wherein the structure-engaging insert includes a fixed base plate having multiple fastener holes spaced apart to resist rotation of the base plate relative to the structure.

In any embodiment, a wall fastener system may be provided, wherein the structure-engaging insert includes a pivoting insert including a protruding threaded connector mounted to the base plate by a pivot joint permitting pivoting of the protruding threaded connector relative to the base plate.

In any embodiment, a wall fastener system may be provided, wherein the pivot joint includes at least one pin extending from the protruding threaded connector and received in a corresponding housing portion of the base plate to permit rotation of the protruding threaded connector relative to the base plate.

In any embodiment, a wall fastener system may be provided, wherein the protruding threaded connector includes a cutout configured to increase a range of pivoting motion of the protruding threaded connector relative to the base plate.

In any embodiment, a wall fastener system may be provided, wherein the structure-engaging insert further includes:
(a) a ball portion connected to the protruding threaded connector; and
(b) a locking nut configured to engage the ball-and-socket joint to selectively resist articulation of the protruding threaded connector relative to the base plate.

In any embodiment, a wall fastener system may include an extender having a body with a threaded portion configured to threadedly connect to the protruding threaded connector of the pivoting insert so as to adjust a distance between the base plate and the top plate.

In any embodiment, a wall fastener system may include an outer cladding element secured to the slotted rail.

In any embodiment, a wall fastener system may be provided, wherein the rail-engaging insert includes a radial aperture, and further including a set screw configured to extend into the radial aperture to lock the rail-engaging insert to the structure-engaging insert.

In any embodiment, a wall fastener system may be provided, wherein the spacer includes a solid central portion disposed between threaded portions of the spacer.

In any embodiment, a wall fastener system may be provided, wherein the spacer includes an intermediate plate disposed between the base plate and the top plate.

The following clauses describe embodiments that are within the scope of the presently disclosed invention:

Clause 1. A wall fastener system comprising: (a) a structure-engaging insert configured to be secured to a structure, the structure-engaging insert including a base plate and a protruding threaded connector extending outwardly from the base plate; and (b) a rail-engaging insert including a top plate and a protruding threaded connector extending from the top plate toward the structure, (c) wherein the protruding threaded connector of the rail-engaging insert is threadedly connected to the protruding threaded connector of the structure-engaging insert so as to selectively vary a spacing between the base plate and the top plate of the rail-engaging insert.

Clause 2. The wall fastener system of any other clause set forth herein, further comprising a slotted rail secured to the top plate of the rail-engaging insert, the slotted rail being spaced from the base plate.

Clause 3. The wall fastener system of any other clause set forth herein, further comprising a locking element configured to secure the structure-engaging insert and the rail-engaging insert against relative rotation.

Clause 4. The wall fastener system of any other clause set forth herein, further comprising a spacer disposed between the rail-engaging insert and the structure-engaging insert, the spacer being threadedly connected to each to increase the spacing between the base plate and the top plate.

Clause 5. The wall fastener system of any other clause set forth herein, wherein the slotted rail includes a primary panel and a leg intersecting the primary panel to define a slot configured to receive the top plate of the rail-engaging insert.

Clause 6. The wall fastener system of any other clause set forth herein, wherein the slotted rail further includes a second leg disposed opposite the leg and configured to capture the top plate between the slot and the second leg.

Clause 7. The wall fastener system of any other clause set forth herein, wherein the slotted rail comprises a pair of opposing legs, each leg including a foot extending generally parallel to the primary panel so as to form two slots for receiving the top plate of the rail-engaging insert.

Clause 8. The wall fastener system of any other clause set forth herein, wherein the structure-engaging insert comprises a fixed base plate having multiple fastener holes spaced apart to resist rotation of the base plate relative to the structure.

Clause 9. The wall fastener system of any other clause set forth herein, wherein the structure-engaging insert comprises a pivoting insert including a protruding threaded connector mounted to the base plate by a pivot joint permitting pivoting of the protruding threaded connector relative to the base plate.

Clause 10. The wall fastener system of clause 9, wherein the pivot joint comprises at least one pin extending from the protruding threaded connector and received in a corresponding housing portion of the base plate to permit rotation of the protruding threaded connector relative to the base plate.

Clause 11. The wall fastener system of clause 9, wherein the protruding threaded connector includes a cutout configured to increase a range of pivoting motion of the protruding threaded connector relative to the base plate.

Clause 12. The wall fastener system of any other clause set forth herein, wherein the structure-engaging insert comprises an articulating insert having a ball-and-socket joint disposed between the base plate and the protruding threaded connector to permit multi-axis adjustment of the protruding threaded connector relative to the base plate.

Clause 13. The wall fastener system of clause 12, further comprising
(a) a ball portion connected to the protruding threaded connector; and
(b) a locking nut configured to engage the ball-and-socket joint to selectively restrict articulation of the protruding threaded connector relative to the base plate.

Clause 14. The wall fastener system of clause 9, further comprising an extender having a body with a threaded portion configured to threadedly connect to the protruding threaded connector of the pivoting insert so as to adjust a distance between the base plate and the top plate.

Clause 15. The wall fastener system of clause 2, further comprising an outer cladding element secured to the slotted rail.

Clause 16. The wall fastener system of clause 3, wherein the rail-engaging insert includes a radial aperture, and further comprising a set screw configured to extend into the radial aperture to lock the rail-engaging insert to the structure-engaging insert.

Clause 17. The wall fastener system of any other clause set forth herein, wherein the spacer includes a solid central portion disposed between threaded portions of the spacer.

Clause 18. The wall fastener system of any other clause set forth herein, wherein the spacer includes an intermediate plate disposed between the base plate and the top plate.

### BRIEF DESCRIPTION OF THE SEVERAL VIEWS OF THE DRAWINGS

The following detailed description will be better understood when read in conjunction with the appended drawings. For the purpose of illustrating the invention, there are shown in the drawings various embodiments, including embodiments which may be presently preferred. It should be understood, however, that the invention is not limited to the precise arrangements and instrumentalities shown. In the drawings, all of which are at least partially schematic:

FIG. 1 is a front right perspective exploded view of a wall fastener system according to the present disclosure including a first embodiment of a slotted rail;

FIG. 2 is a side sectional view of a structure-engaging insert for the wall fastener system of FIG. 1;

FIG. 3 is a rear isometric view of the structure-engaging insert of FIG. 2;

FIG. 4 is a front isometric view of the structure-engaging insert of FIG. 2;

FIG. 5 is a side elevational view of a rail-engaging insert for the wall fastener system of FIG. 1;

FIG. 6 is a front isometric view of the structure-engaging insert of FIG. 5;

FIG. 7 is a rear isometric view of the structure-engaging insert of FIG. 5;

FIG. 8 is a front elevational view of a spacer for the wall fastener system of FIG. 1;

FIG. 9 is a side sectional view of the spacer insert of FIG. 8;

FIG. 10 is a rear isometric view of the spacer of FIG. 8;

FIG. 11 is a sectional view of a second embodiment of a slotted rail for use with the wall fastener system of FIG. 1, taken along line 11-11 of FIG. 12;

FIG. 12 is an isometric view of an assembly including the slotted rail of FIG. 11;

FIG. 13 is an isometric view of a portion of an assembly including the slotted rail of FIG. 11;

FIG. 14 is a right side elevational view of the assembly of FIG. 12;

FIG. 15 is a sectional view of an alternative slotted rail for use in a wall fastener system, taken along line 15-15 of FIG. 17;

FIG. 16 is an isometric partial view of the alternative slotted rail of FIG. 15, as used in a wall fastener system;

FIG. 17 is a side elevational view of system including the slotted rail of FIG. 15;

FIG. 18 is an isometric view of an alternative embodiment of the system;

FIG. 19 is an isometric view of a alternative structure-engaging insert for use in the system of FIG. 18;

FIG. 20 is an elevational view of the alternative structure-engaging insert of FIG. 19;

FIG. 21 is an isometric view of a rail-engaging insert for use in the system of FIG. 18;

FIG. 22 is an isometric view of a pivoting structure-engaging insert for use in systems as disclosed herein; and

FIG. 23 is a side elevational view of the pivoting structure-engaging insert of FIG. 22;

FIG. 24 is a sectional view of the pivoting structure-engaging insert of FIG. 22, taken along line 24-24 of FIG. 23;

FIG. 25 is a partial isometric view of the pivoting structure-engaging insert of FIG. 22;

FIG. 26 is a partial isometric view of the pivoting structure-engaging insert of FIG. 22;

FIG. 27 is a partial elevational view of the pivoting structure-engaging insert of FIG. 22;

FIG. 28 is an alternative partial elevational view of the pivoting structure-engaging insert of FIG. 22;

FIG. 29 is an isometric view of an extender for use with systems disclosed herein;

FIG. 30 is an isometric view of an articulating structure-engaging insert for use in systems as disclosed herein; and

FIG. 31 is a side elevational view of the articulating structure-engaging insert of FIG. 30;

FIG. 32 is a sectional view of the articulating structure-engaging insert of FIG. 30, taken along line 32-32 of FIG. 31;

FIG. 33 is a partial isometric view of the pivoting structure-engaging insert of FIG. 30;

FIG. 34 is a partial elevational view of the pivoting structure-engaging insert of FIG. 30;

FIG. 35 is a partial sectional view of the pivoting structure-engaging insert of FIG. 30, taken along the line 35-35 of FIG. 34;

FIG. 36 is an isometric view of a rail-engaging insert for use with the articulating structure-engaging insert of FIG. 30; and

FIG. 37 is a side elevational view of the rail-engaging insert of FIG. 36.

### DETAILED DESCRIPTION

Certain terminology is used in the following description for convenience only and is not limiting. The words “right,” “left,” “lower,” and “upper” designate directions in the drawings to which reference is made. The words “inner” and “outer” refer to directions toward and away from, respectively, the geometric center of an object and designated parts thereof. Unless specifically set forth otherwise herein, the terms “a,” “an,” and “the” are not limited to one element but instead should be read as meaning “at least one.” “At least one” may occasionally be used for clarity or readability, but such use does not change the interpretation of “a,” “an,” and “the.” Moreover, the singular includes the plural, and vice versa, unless the context clearly indicates otherwise. As used herein, the terms “proximal” and “distal” are relative terms referring to locations or elements that are closer to (proximal) or farther from (distal) with respect to other elements, the user, or designated locations. “Including” as used herein means “including but not limited to.” The word “or” is inclusive, so that “A or B” encompasses A and B, A only, and B only. The terms “about,” “approximately,” “generally,” “substantially,” and like terms used herein, when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit thereof.

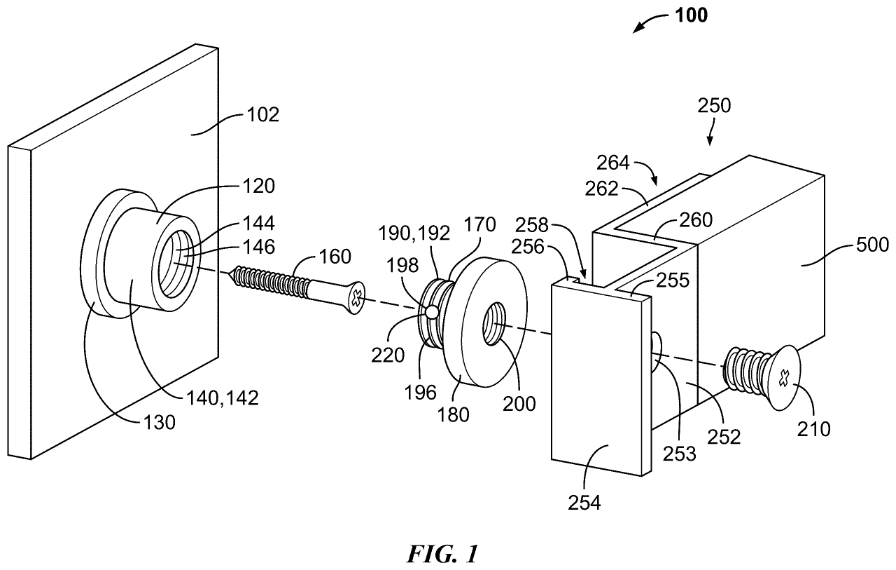

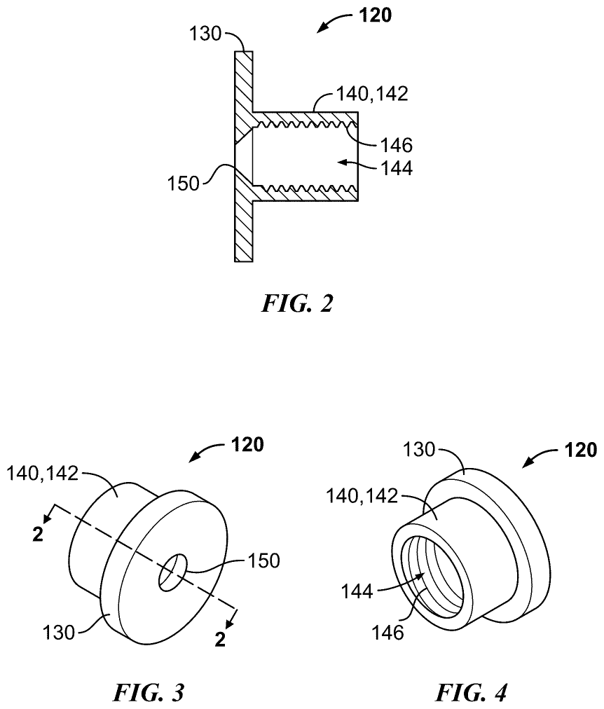

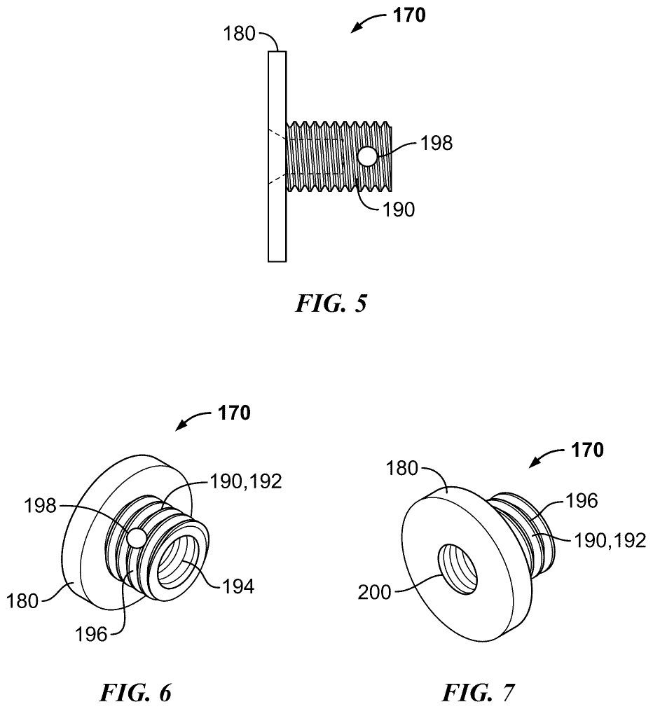

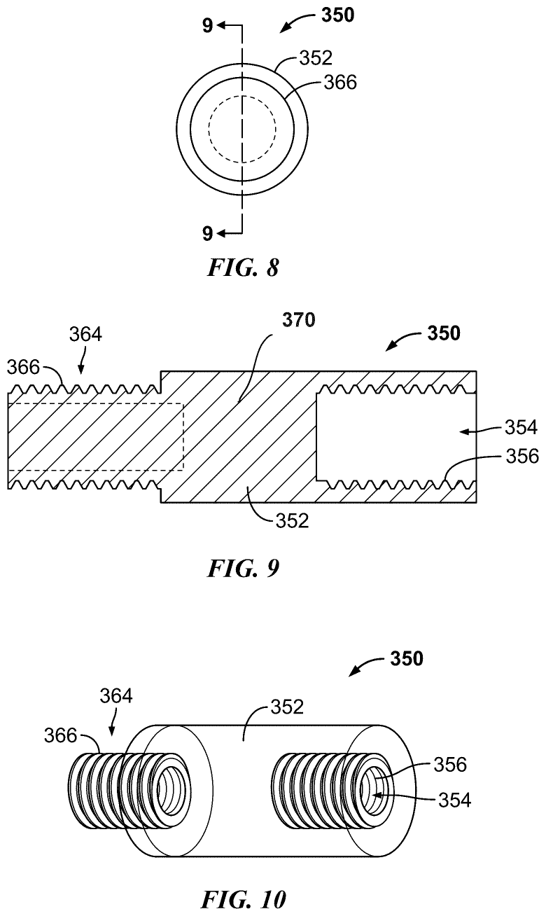

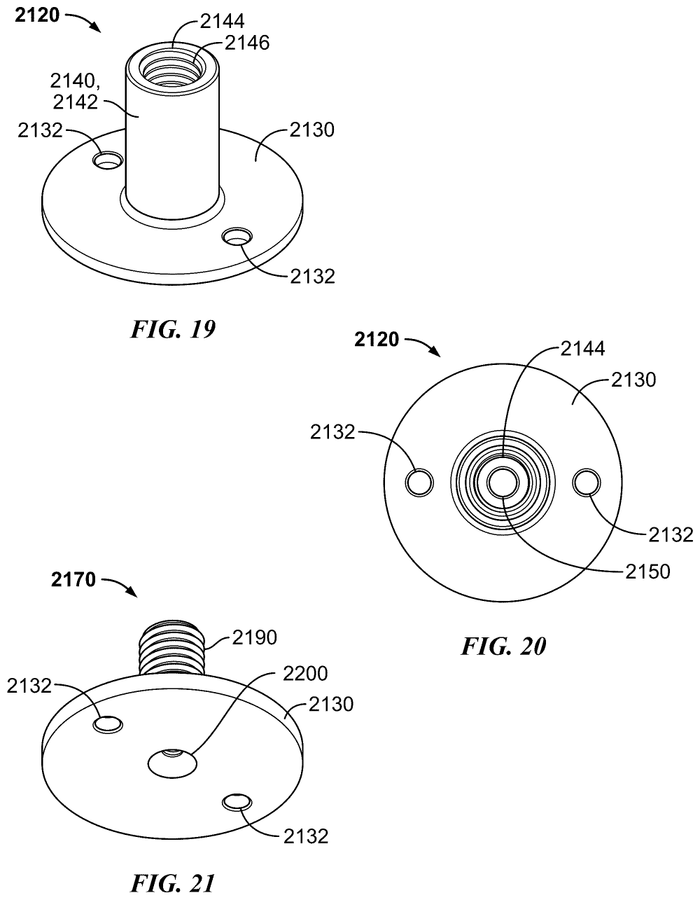

In one aspect, referring to FIGS. 1-22, a wall fastener system 100 is disclosed. Referring to FIGS. 1 and 2, the wall fastener system 100 is configured for attachment to structure, which is shown as a wall 102 but may be a ceiling, floor, or other body suitable for attachment and support of the system 100. As will be explained in more detail below, a structure-engaging insert 120 is fixed to the wall 102. A rail-engaging insert 170 threadedly engages the structure-engaging insert 120, providing an adjustable support to connect a slotted rail 250 or a second slotted rail 300 to the wall 102.

Referring now to FIGS. 1 through 6, the wall fastener system 100 includes a structure-engaging insert 120 for attachment to the wall 102. The structure-engaging insert 120 includes a base plate 130, a protruding threaded connector 140, and may have a bore-aligned fastener hole 150 passing through the base plate 130. The base plate 130 is configured to be placed against the wall 102, with the protruding threaded connector 140 protruding outwardly from the wall. The protruding threaded connector 140 has a body 142 (which may be tubular or cylindrical) with a bore 144 and threads 146. The bore 144 may be aligned with the bore-aligned fastener hole 150, as in the illustrated embodiment. Here the threads 146 are internal threads. The threads of the structure-engaging insert 120 could alternatively be male threads, with an accompanying change of the threads of the rail-engaging insert 170 to compatible female threads. A fastener 160 is configured to engage the wall 102 or other body to which the system 100 is attached. In the embodiment of FIGS. 1-12, the fastener 160 is threaded screw such as a wood screw, masonry screw, or the like adapted to fix the structure-engaging insert 120 by passing through the bore-aligned fastener hole 150 and engaging the wall 102.

Referring now to FIGS. 1 and 7 through 11, the wall fastener system 100 includes a rail-engaging insert 170 for attachment to the wall 102. The rail-engaging insert 170 includes a top plate 180, a protruding threaded connector 190, and may have a bore-aligned fastener hole 200 passing through and centrally located in the top plate 180. The top plate 180 is configured to be placed against the wall 102, with the protruding threaded connector 190 protruding from the top plate 180 toward the wall 102. The protruding threaded connector 190 has a tubular body 192 and a bore 194 with threads 196 and may have a locking element configured to secure the structure-engaging insert and the rail-engaging insert against relative rotation. The locking element may take the form of a radial aperture 198 configured to engage a set screw 220 (FIG. 1) to secure the structure-engaging insert 120 to the rail-engaging insert 170 once the structure-engaging insert 120 to the rail-engaging insert 170 are adjusted to provide the desired depth to an attached rail (as described below). The bore 194 may be aligned with the bore-aligned fastener hole 200, as in the illustrated embodiment. Here the threads 196 are external threads, hence the designation as a “male insert.” The threads of the rail-engaging insert 170 could alternatively be female threads, with an accompanying change of the threads of the structure-engaging insert 120 to compatible male threads. A fastener 210 is configured to engage the wall bore-aligned fastener hole 200. In the embodiment of FIGS. 1-12, the fastener 210 is threaded screw such machine screw or the like adapted to engage a slotted rail 250 or a second slotted rail 300 by passing through the slotted rail 250 or the second rail 250 and engaging the fastener hole 200.

The threads 196 of the rail-engaging insert 170 are configured to engage the threads 146 of the structure-engaging insert 120. The rail-engaging insert 170 may be turned to increase or decrease the overlap between the threads 146 of the structure-engaging insert 120 and the threads 196 of the rail-engaging insert 170, this adjusting the distance between the wall 102 and the top plate 180 of the rail-engaging insert 170. As a result, the structure-engaging insert 120 and the rail-engaging insert 170 serve as an adjustable-depth shim between the wall 102 and the slotted rail 250 or the second slotted rail 300. The rail-engaging insert 170 and the structure-engaging insert 120 may be threadedly engaged to create a selected depth between the wall 102 and the slotted rail 250 or the second slotted rail 300. The structure-engaging insert 120 and the rail-engaging insert 170 may then be locked with respect to one another to maintain the selected depth.

Referring to FIGS. 8-15, the system 100 optionally may include a spacer 350 engaged with and disposed between the structure-engaging insert 120 and the rail-engaging insert 170 to provide for a greater selected depth between the wall 102 and the rail 250 or the second slotted rail 300. The spacer 350 has a body 352 (which may be tubular or cylindrical) having a bore 354 with internal threads 356 (as shown) or external threads (if needed for compatibility with a male-threaded wall-engaging insert and a female-threaded rail-engaging insert), and an externally threaded portion 364 with external threads 366 (or internal threads, if needed for compatibility with a male-threaded wall-engaging insert and a female-threaded rail-engaging insert). In the illustrated example, the internal threads 356 of the spacer 350 are configured to engage the external threads 196 of the rail-engaging insert 170, while the external threads 366 are configured to engage the internal threads 146 of the structure-engaging insert 120. The spacer 350 may have a solid central portion 370 (FIG. 9) disposed between the internal threads 356 and the external threads 366 and/or the externally threaded portion 364.

Referring to FIG. 1, the system 100 may include a slotted rail 250. The slotted rail 250 includes a primary panel 252 with a hole 253 so that the fastener 210 may engage both the slotted rail 250 and the bore-aligned fastener hole 200 of the rail-engaging insert 170 to secure the slotted rail 250 to the rail-engaging insert 170. The primary panel 252 may be essentially rectangular and may have a leg 254 intersecting the primary panel 252 and extending transversely with respect thereto both toward and away from the position of the wall 102 when the system 100 is in the mounted position with the base plate 130 in contact with and aligned with the surface of the wall 102. The leg 254 may have a forwardly extending portion 255 and may serve to provide a finished edge to conceal an end portion or edge portion of a wall that would otherwise be visible. The leg 254 in turn may include a foot 256 extending parallel to the primary panel 252. The foot 256 may extend and may be configured so that the leg 254 and the foot 256 may combine to form and define a slot 258, the slot 258 being essentially u-shaped. The primary panel 252 may have a second leg 260 also extending transversely with respect thereto and toward and away from the position of the wall 102 when the system 100 is in the mounted position with the base plate 130 in contact with and aligned with the surface of the wall 102. The primary panel 252 is sized, and the leg 254 and the second leg 260 are configured, so that the top plate 180 of the rail-engaging insert may be fitted into the slot 258, while at the same time the top plate 180 is fitted between the slot 258 and the second leg 260. The second leg 260 may include a second foot 262 extending parallel to the primary panel 252. The second leg 260 and the slot 258 may be configured to capture the top plate between the slot 258 and the second leg 260. The second foot 262 may extend and may be configured so that the second leg 260 and the second foot 262 form an L-shaped extension 264 of the primary panel 252. The L-shaped extension is configured to meet an edge portion of an outer panel or outer cladding element 502 or other element being attached to a structure such as a wall 102 using the system.

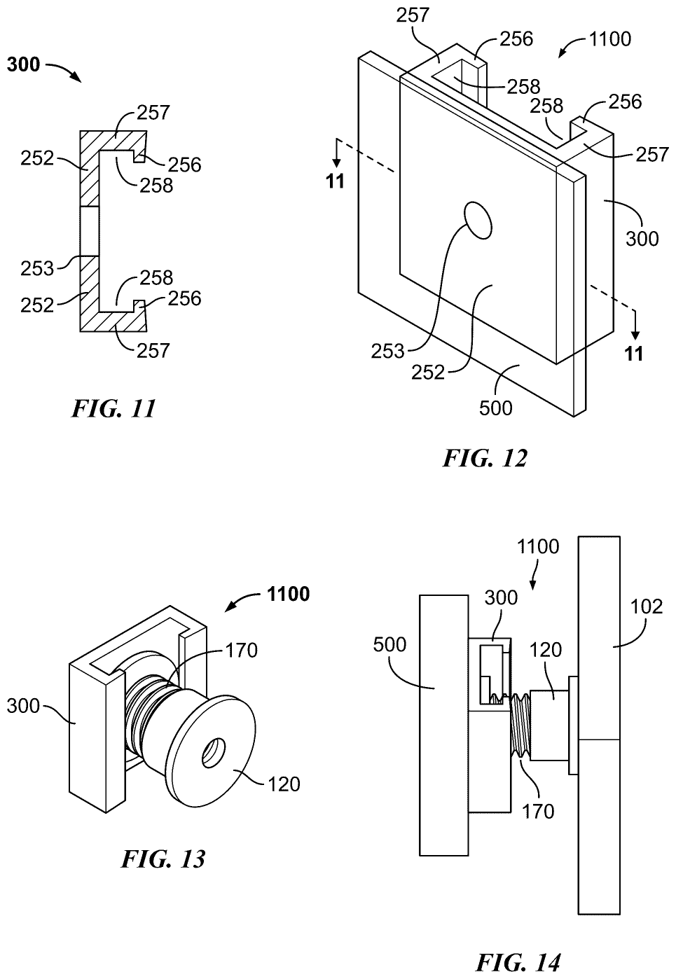

Referring to FIGS. 11-14, a system 1100 may include a second slotted rail 300. The second slotted rail 300 includes some elements of the slotted rail 250 but differs in being more compact for a given size of base plate 130 and rail-engaging insert 170 that the second slotted rail 300 can accommodate. The second slotted rail 300 includes a primary panel 252 with a hole 253 so that the fastener 210 may engage both the second slotted rail 300 and the bore-aligned fastener hole 200 of the rail-engaging insert 170 to secure the second slotted rail 300 to the rail-engaging insert 170. The primary panel 252 may be essentially rectangular or square and may have a leg 257 intersecting the primary panel 252 at each of two opposing sides thereof and extending transversely with respect thereto toward the position of the wall 102 when the system 100 is in the mounted position with the base plate 130 in contact with and aligned with the surface of the wall 102. Each leg 257 in turn may include a foot 256 extending parallel to the primary panel 252. The foot 256 may extend and may be configured so that the leg 257 and the foot 256 may combine to form a slot 258. Two slots 258 are shown in the illustrated embodiment and are configured (shaped and spaced) for receiving the top plate of the rail-engaging insert 170. The primary panel 252 is sized, and the legs 257 are configured, so that the top plate 180 of the rail-engaging insert 170 may be fitted into the slots 258. A cladding element 500 may be secured to the second slotted rail 300 by way of a fastener passing through the cladding element 500 and the hole 253, or by the cladding element 500 being otherwise fixed to the second slotted rail 300.

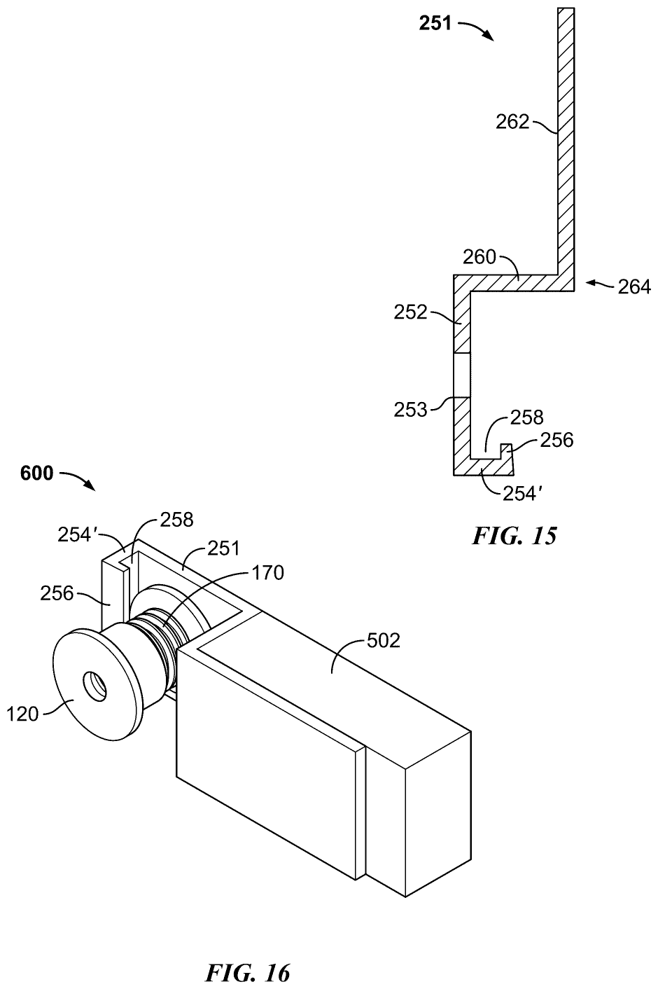

Referring to FIGS. 15-16, the system 600 as in FIG. 16 may include an alternative slotted rail 251, which incorporates most of the elements of the slotted rail 250, with the exception of the leg 254′, which replaces the leg 254 of the slotted rail 250. The alternative slotted rail 251 includes a primary panel 252 with a hole 253 so that the fastener 210 may engage both the alternative slotted rail 251 and the bore-aligned fastener hole 200 of the rail-engaging insert 170 to secure the alternative slotted rail 251 to the rail-engaging insert 170. The primary panel 252 may be essentially rectangular and may have the leg 254′ intersecting the primary panel 252 and extending transversely with respect thereto toward the position of the wall 102 when the system 100 is in the mounted position with the base plate 130 in contact with and aligned with the surface of the wall 102. The leg 254′ in turn may include a foot 256 extending parallel to the primary panel 252. The foot 256 may extend and may be configured so that the leg 254′ and the foot 256 may combine to form a slot 258. The primary panel 252 may have a second leg 260 also extending transversely with respect thereto and toward and away from the position of the wall 102 when the system 100 is in the mounted position with the base plate 130 in contact with and aligned with the surface of the wall 102. The primary panel 252 is sized, and the leg 254′ and the second leg 260 are configured, so that the top plate 180 of the rail-engaging insert 170 (sometimes called a male connector), or another rail-engaging insert, may be fitted into the slot 258, while at the same time the top plate 180 is fitted between the slot 258 and the second leg 260. The second leg 260 may include a second foot 262 extending parallel to the primary panel 252. The second foot 262 may extend and may be configured so that the second leg 260 and the second foot 262 form an L-shaped extension 264 of the primary panel 252.

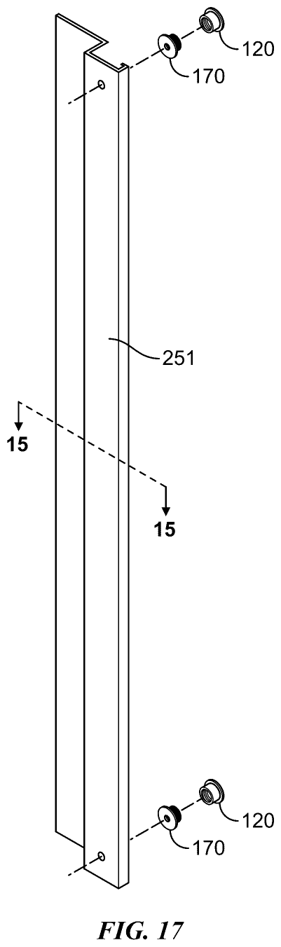

FIG. 17 is a partial perspective exploded view of a system according to the present disclosure. An alternative slotted rail 251 is configured to be attached to a structure by at least a structure-engaging insert 120 and a rail-engaging insert 170 (two of each are shown).

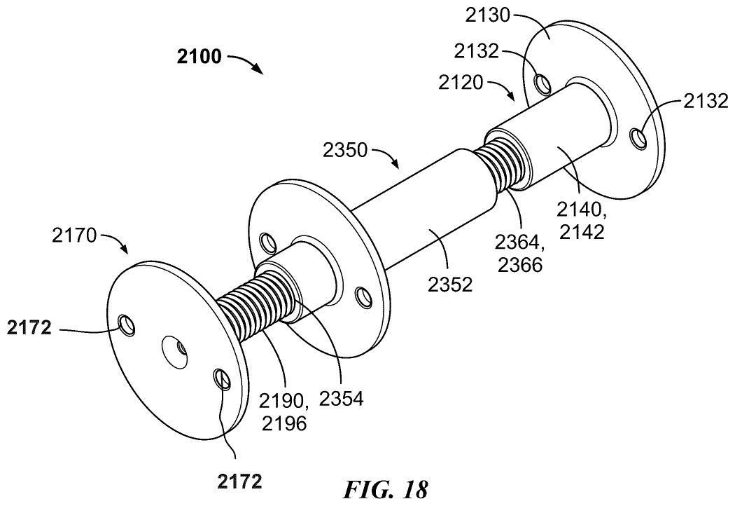

Referring to FIGS. 18-21, an alternative embodiment of the system 2100 may include an alternative structure-engaging insert 2120 with an alternative fixed base plate 2130 for engaging a wall 102 or other structure as described with respect to the system 100 and the base plate 130. The alternative fixed base plate 2130 has holes 2132 spaced apart for securing the alternative structure-engaging insert 2120 to a structure and/or stabilizing the alternative fixed base plate 2130 against rotation by providing two points of fixation to the structure. The protruding threaded connector 2140 has a body 2142 (which may be tubular or cylindrical) with a bore 2144 and threads 2146. The bore 2144 may be aligned with a bore-aligned fastener hole 2150, as in the illustrated embodiment. Here the threads 2146 are internal threads. The threads of the structure-engaging insert 2120 could alternatively be male threads, with an accompanying change of the threads of the rail-engaging insert 2170 to compatible female threads. A fastener 160 (FIG. 1) may be inserted into any of the bore-aligned fastener hole 2150 or the holes 2132 to engage the wall 102 or other body to which the system is attached.

An alternative rail-engaging insert 2170 threadedly engages the alternative structure-engaging insert 2120, providing an adjustable support to connect a slotted rail 250 or a second slotted rail 300 to a structure such as the wall 102. As with the alternative structure-engaging insert 2120, the rail-engaging insert 2170 has two holes 2172 for engagement of a structure or other element such as the slotted rail 250, the second slotted rail 300, the cladding element 500, and/or the outer cladding element 502.

A spacer 2350 of an alternative type is configured to engage the alternative structure-engaging insert 2120 in a manner analogous to the structure-engaging insert 120 and the spacer 350, which are discussed above. The spacer 2350 has a body 2352 (which may be tubular or cylindrical) having a bore 2354 with internal threads (see bore 354 of the spacer 350) or external threads (if needed for compatibility with a male-threaded wall-engaging insert and a female-threaded rail-engaging insert), and an externally threaded portion 2364 with external threads 2366 (or internal threads, if needed for compatibility with a male-threaded wall-engaging insert and a female-threaded rail-engaging insert). In the illustrated example, the internal threads of the spacer 2350 are configured to engage external threads 2196 of a protruding threaded connector 2190 of a rail-engaging insert 2170, while the external threads 2366 are configured to engage the internal threads 2146 of the structure-engaging insert 2120. The spacer 2350 may have a solid central portion disposed between the internal threads and the external threads 2366 and/or the externally the threaded portion 2364. The spacer 2350 may include an intermediate plate 2351. The intermediate plate 2351 may include additional holes 2353 and may provide intermediate engagement disposed between a structure and a cladding layer placed externally (see cladding element 500, outer cladding element 502).

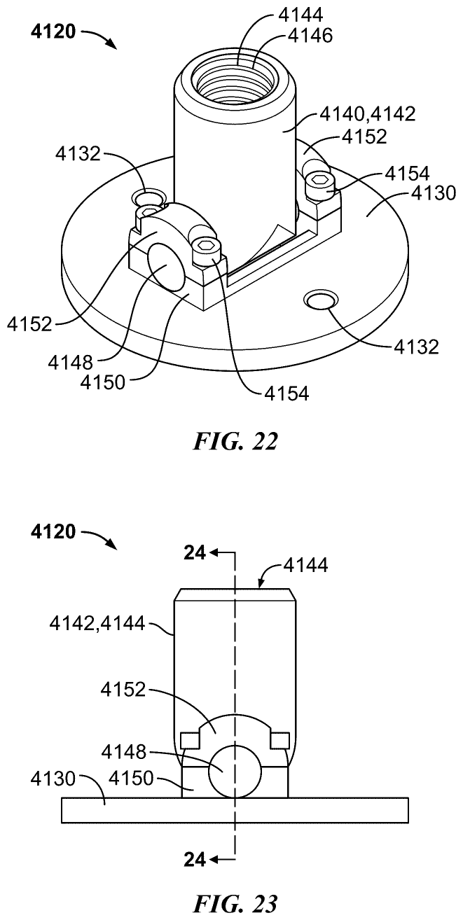

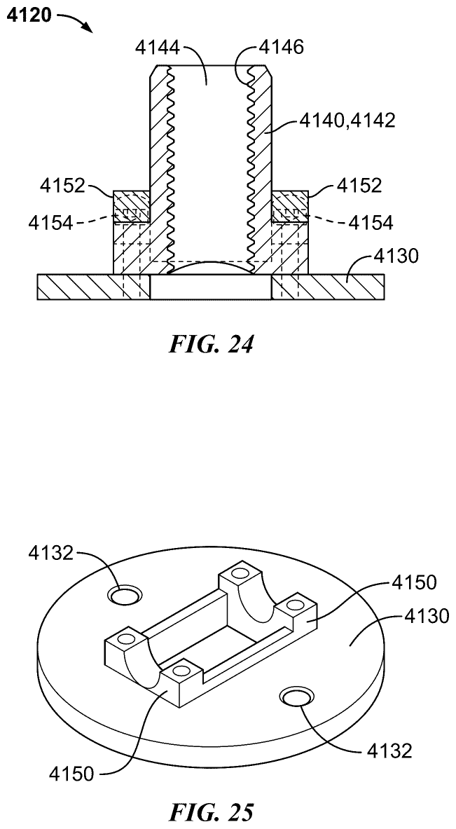

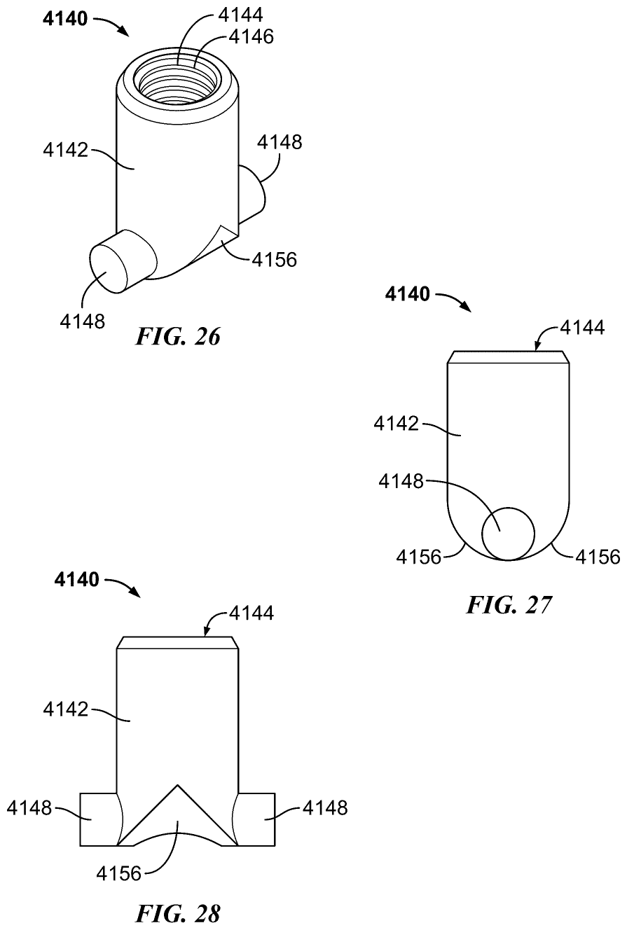

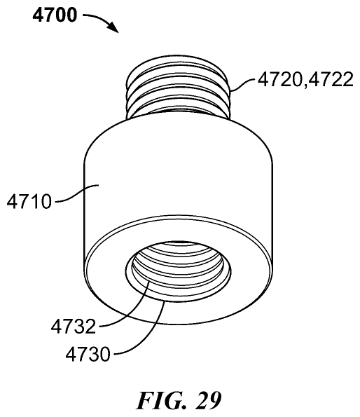

Referring now to FIGS. 22-29, in the system 2100 (or any system disclosed herein) the alternative structure-engaging insert 2120 may be replaced by a movable structure-engaging insert. One type of movable structure-engaging insert is a pivoting structure-engaging insert 4120. The pivoting structure-engaging insert 4120 includes as alternative fixed base plate 4130 with holes 4132 for attachment and stabilization, comparable to similar holes described above. The pivoting structure-engaging insert 4120 has a protruding threaded connector 4140 with a bore 4144 and internal threads 4146. (The protruding threaded connector 4140 could instead be formed with male threads, with the connecting elements having compatible female threads.) The protruding threaded connector 4140 has a pivot joint comprising a pin 4148, of which two are located on opposite sides of the protruding threaded connector 4140. The alternative fixed base plate 4130 has a lower housing portion 4150, of which two are shown. Each pin 4148 fits within, is received within, and rotates within a corresponding lower housing portion 4150, in the manner of a plain bearing, to permit rotation of the protruding threaded connector 4140 relative to the alternative fixed base plate 4130. On each side of the protruding threaded connector 4140, an upper housing portion 4152 is attached to the alternative fixed base plate 4130, fixed in place by screws 4154, in operative relation with a corresponding lower housing portion 4150, so that the upper housing portion 4152 and the lower housing portion 4150 together form a housing in which the pin 4148 is located and may rotate or pivot. This arrangement allows for pivoting between the protruding threaded connector 4140 (and elements engaged therewith) and the structure (such as the wall 102) to which the alternative fixed base plate 4130 is attached. A cutout 4156 on the body 4142 of the protruding threaded connector 4140 (two are shown) may allow for a greater range of pivoting motion of the protruding threaded connector 4140. Referring to FIG. 29, an extender 4700 has a body 4710, a threaded portion 4720 with external threads 4722, and a bore 4730 with internal threads 4732. The extender may engage with the internal threads 4146 of the protruding threaded connector 4140, or with any externally threaded element disclosed herein, to adjust a distance between a structure such as a wall 102 and elements connected to the alternative fixed base plate 4130, or between other connectable elements disclosed herein.

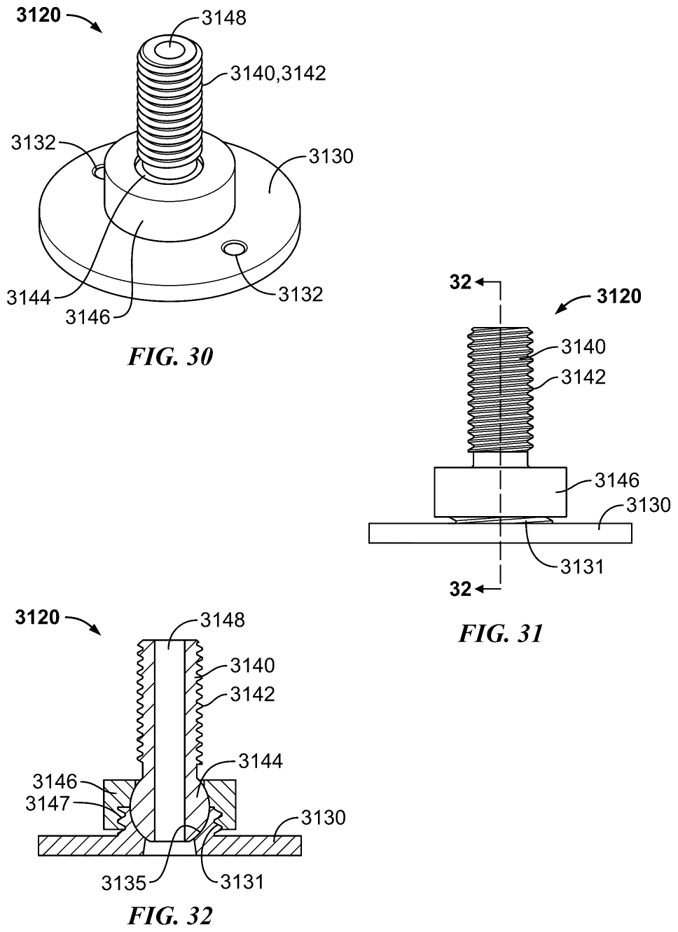

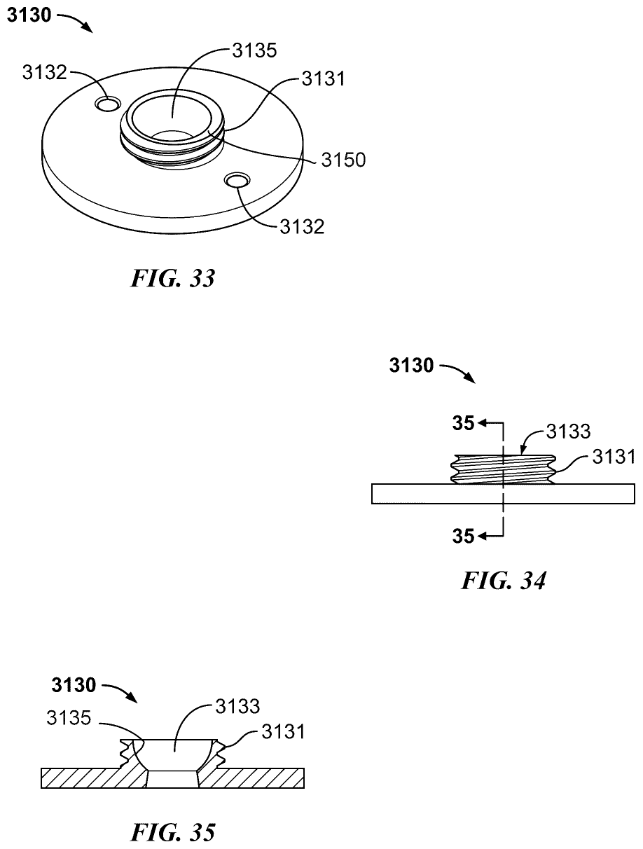

Referring now to FIGS. 30-37, a second type of movable structure-engaging insert is an articulating structure-engaging insert 3120. The articulating structure-engaging insert 3120 includes an alternative fixed base plate 3130 with holes 3132 for attachment and stabilization, comparable to similar holes described above. The alternative fixed base plate 3130 has a socket connector 3150 with external threads 3131, a bore 3133 (FIGS. 33-35), and a socket surface 3135. The socket surface 3135 is curved and as illustrated takes the form of an interior surface of a truncated sphere. (The socket connector 3150 may instead be formed with female threads, with the connecting elements having compatible male threads.) A shaft portion 3140 has external threads 3142, a connected ball portion 3144 with a spherical exterior surface, and a bore 3148. (The shaft portion 3140 could instead be formed with internal threads, with connecting elements having compatible external threads.) The socket surface 3135 and the ball portion 3144 together form a ball-and-socket joint allowing for articulating or multi-axis movement of the shaft portion 3140 with respect to the base plate 3130 while the shaft portion 3140 and the base plate 3130 remain connected by the ball-and-socket joint. A locking nut 3146 fits over the shaft portion 3140 when the shaft portion 3140 is positioned in the socket connector 3150 in contact with the socket surface 3135. The locking nut 3146 has internal threads 3147 (FIG. 32) for engaging the external threads 3131 of the socket connector 3150 (FIG. 33) and is configured to be tightened to provide resistance to articulation of the ball portion 3144, with greater tightening leading to greater resistance to articulation. This arrangement allows for articulation between the ball portion 3144 and the shaft portion 3140 (and elements engaged therewith) and the structure (such as the wall 102) to which the alternative fixed base plate 3130 is attached. The locking nut 3146 may be loosened to allow articulation during assembly and adjustment of the orientation of the shaft portion 3140 and then tightened once the desired orientation of the shaft portion 3140 has been set.

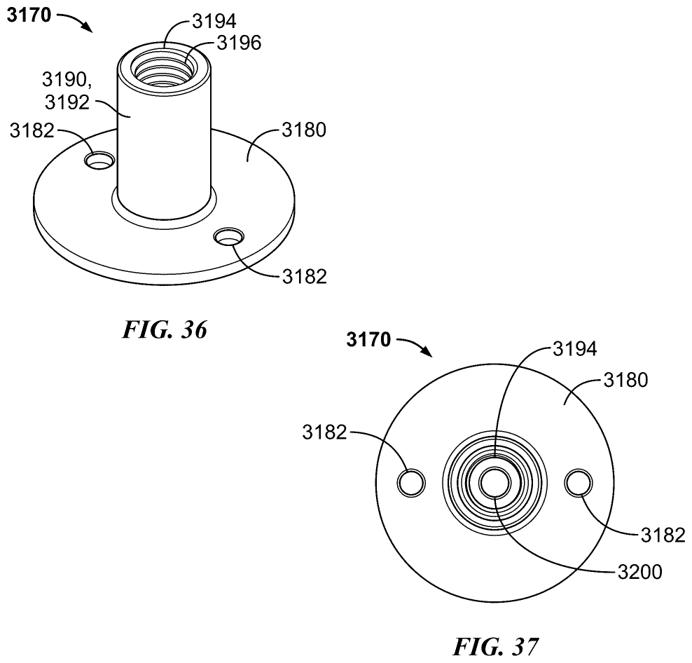

Referring to FIGS. 36 and 37, an alternative rail-engaging insert 3170 is configured to threadedly engage the articulating structure-engaging insert 3120, providing an adjustable support to connect a slotted rail 250, an alternative slotted 251, or a second slotted rail 300 (any of which constitutes a “slotted rail”) to a structure such as the wall 102. The alternative rail-engaging insert 3170 has a protruding threaded connector 3190 with a body 3192 having a bore 3194 and internal threads 3196. As with the alternative rail-engaging insert 2170, the alternative rail-engaging insert 3170 has a top plate 3180 with two holes 3182 for engagement of a structure or other element such as the slotted rail 250, the second slotted rail 300, the cladding element 500, and/or the outer cladding element 502. The two holes 3182 are spaced apart for securing the alternative rail-engaging insert 3170 to a structure and/or stabilizing the alternative rail-engaging insert 3170 against rotation by providing two points of fixation to the slotted rail 250, the second slotted rail 300, the cladding element 500, and/or the outer cladding element 502. The alternative rail-engaging insert 3170 may also have a bore-aligned fastener hole 3200, aligned with the bore and passing through and centrally located in the top plate 3180.

The elements shown in FIGS. 30-37 are compatible with the spacer 350 and the spacer 2350 as described above.

Embodiments of the system 100, 600, 1100, 2100 allow the position of each slotted rail to be adjusted independently. As a result, the positions of the slotted rail 250, the alternative slotted rail 251, and the second slotted rail 300 can be readily aligned by adjusting the relative positions of the respective structure-engaging inserts 120 and rail-engaging inserts 170 through relative rotation thereof. (This is so regardless of whether the structure-engaging inserts are mounted adjacent to the wall as in FIG. 1 or whether the male and female threads are reversed.) Use of the systems disclosed herein is much faster and easier than aligning building components using traditional shimming techniques.

With respect to the methods and processes described herein, those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present disclosure.

I claim:

1. A wall fastener system comprising:
(a) a structure-engaging insert configured to be secured to a structure, the structure-engaging insert including a base plate and a protruding threaded connector extending outwardly from the base plate; and
(b) a rail-engaging insert including a top plate and a protruding threaded connector extending from the top plate toward the structure,
(c) wherein the protruding threaded connector of the rail-engaging insert is threadedly connected to the protruding threaded connector of the structure-engaging insert so as to selectively vary a spacing between the base plate and the top plate of the rail-engaging insert.

2. The wall fastener system of claim 1, further comprising a slotted rail secured to the top plate of the rail-engaging insert, the slotted rail being spaced from the base plate.

3. The wall fastener system of claim 1, further comprising a locking element configured to secure the structure-engaging insert and the rail-engaging insert against relative rotation.

4. The wall fastener system of claim 1, further comprising a spacer disposed between the rail-engaging insert and the structure-engaging insert, the spacer being threadedly connected to each to increase the spacing between the base plate and the top plate.

5. The wall fastener system of claim 2, wherein the slotted rail includes a primary panel and a leg intersecting the primary panel to define a slot configured to receive the top plate of the rail-engaging insert.

6. The wall fastener system of claim 5, wherein the slotted rail further includes a second leg disposed opposite the leg and configured to capture the top plate between the slot and the second leg.

7. The wall fastener system of claim 5, wherein the slotted rail comprises two opposing legs, each leg including a foot extending parallel to the primary panel so as to form two slots configured for receiving the top plate of the rail-engaging insert.

8. The wall fastener system of claim 1, wherein the structure-engaging insert comprises a fixed base plate having multiple fastener holes spaced apart to resist rotation of the base plate relative to the structure.

9. The wall fastener system of claim 1, wherein the structure-engaging insert comprises a pivoting insert including a protruding threaded connector mounted to the base plate by a pivot joint permitting pivoting of the protruding threaded connector relative to the base plate.

10. The wall fastener system of claim 9, wherein the pivot joint comprises a pin extending from the protruding threaded connector and received in a corresponding housing portion of the base plate to permit rotation of the protruding threaded connector relative to the base plate.

11. The wall fastener system of claim 9, wherein the protruding threaded connector includes a cutout configured to increase a range of pivoting motion of the protruding threaded connector relative to the base plate.

12. The wall fastener system of claim 1, wherein the structure-engaging insert comprises an articulating structure-engaging insert including a ball-and-socket joint having a ball portion disposed to permit multi-axis adjustment of the protruding threaded connector relative to the base plate.

13. The wall fastener system of claim 12, further comprising
(a) a ball portion connected to the protruding threaded connector; and
(b) a locking nut configured to engage the ball-and-socket joint to selectively resist articulation of the protruding threaded connector relative to the base plate.

14. The wall fastener system of claim 9, further comprising an extender having a body with a threaded portion configured to threadedly connect to the protruding threaded connector of the pivoting insert so as to adjust a distance between the base plate and the top plate.

15. The wall fastener system of claim 2, further comprising an outer cladding element secured to the slotted rail.

16. The wall fastener system of claim 3, wherein the rail-engaging insert includes a radial aperture, and further comprising a set screw configured to extend into the radial aperture to lock the rail-engaging insert to the structure-engaging insert.

17. The wall fastener system of claim 4, wherein the spacer includes a solid central portion disposed between threaded portions of the spacer.

18. The wall fastener system of claim 4, wherein the spacer includes an intermediate plate disposed between the base plate and the top plate.
